(19) United States
(12) Patent Application Publication
(10) Pub. No.: US 2011/0231502 A1
(43) Pub. Date: Sep. 22, 2011

(54) RELAY APPARATUS, RELAY METHOD AND RECORDING MEDIUM

(75) Inventors: Shingo Umeshima, Hamamatsu-shi (JP); Masayuki Mizushima, Hamamatsu-shi (JP); Yoshinobu Iwasaki, Okazaki-shi (JP)

(73) Assignee: YAMAHA CORPORATION, Hamamatsu-shi, Shizuoka (JP)

(21) Appl. No.: 13/061,795

(22) PCT Filed: Sep. 3, 2009
(86) PCT No.: PCT/JP2009/065429

§ 371 Date: May 17, 2011

(30) Foreign Application Priority Data
Sep. 3, 2008 (JP) 2008-226518

(51) Int. Cl. G06F 15/16

(52) U.S. Cl. 709/206

(57) ABSTRACT

A relay apparatus can easily determine the presence or absence of fabrication in a transmission source electronic mail address of an electronic mail message. The relay apparatus 10-m (m=1, 2, . . . ) obtains a transmission source electronic mail address and trace information from a header field of “From” and a header field of “Received” in a mail header mh of an electronic mail message transmitted to a terminal 20-i (i=1, 2, . . . ) from a mail transfer server apparatus 30-n (n=1, 2, . . . ). Further, in a case where the transmission source electronic mail address and the trace information include a character string of the same domain name, a character string indicating that the transmission source is not fabricated is added to a mail body mb for transmission, and in a case where a character string of the same domain name is not included, a character string indicating that the transmission source is fabricated is added to the mail body mb for transmission.

### TECHNICAL FIELD

The present invention relates to a technique which presents information under the suspicion that a transmission source electronic mail address of an electronic mail is fabricated to a mail receiver.

### BACKGROUND ART

SPF (Sender Policy Framework) has been used as a technique of verifying the presence or absence of fabrication in a transmission source electronic mail address of an electronic mail. In the SPF, IP addresses of a normal SMTP (Simple Mail Transfer Protocol) server for respective domains are listed corresponding to domain names thereof, and are stored in a database or the like of a DNS (Domain Name System) server. Then, in the SPF, in a case where an electronic mail message which uses an account of a mail box of a POP (Post Office Protocol) server as a destination electronic mail address is transferred from an SMTP server, the POP server references whether an IP address of the SMTP server which is a transmission source is present in the list corresponding to a domain name included in the transmission source electronic mail address of the electronic mail message. Then, in a case where a pair of the IP address and the domain name which are for reference is not present in the list, the POP server determines that the electronic mail message is a junk mail transmitted using the SMTP server which is not a normal SMTP server, and refuses to store the electronic mail message in the mail box thereof. Details of the technique are disclosed in NPL 1, for example.

### CITATION LIST

[NPL 1] Sender Policy Framework Project Overview, SPF council, [searched on Jul. 9, 2008], the Internet <http://openspf.org/>

### SUMMARY OF INVENTION

### Technical Problem

However, in the technique disclosed in NPL 1, in a case where a determination error of a POP server is present, an electronic mail message which is to reach a destination terminal from the server may be discarded without delivering. In consideration of this situation, among receivers who receive the electronic mail message, there are many users who want to receive information contributing to determination of the presence or absence of fabrication in a transmission source of the electronic mail message from a mail server such as a POP server or the like, and want to determine whether to receive an electronic mail message from the transmission source thereafter.

An object of the present invention is to provide a technique which allows a receiver of an electronic mail message to easily determine the presence or absence of fabrication in a transmission source electronic mail address of the electronic mail message.

### Solution to Problem

According to an embodiment of the present invention, there is provided a relay apparatus including: a storage section configured to store an electronic mail message; and a transmission source verification processing section that obtains trace information indicating at least a part of a through point of the electronic mail message up to the relay apparatus, from content described in a mail header of the electronic mail message stored in the storage section, determines the presence or absence of fabrication in a transmission source of the electronic mail message on the basis of the trace information, and adds a determination result about the presence or absence of the fabrication to a mail body or the mail header of the electronic mail message for transmission.

### Advantageous Effects of Invention

According to the invention, the relay apparatus obtains trace information from content described in the mail header of the electronic mail message, and determines the presence or absence of fabrication in the transmission source of the electronic mail message on the basis of the trace information. The trace information about the electronic mail message is information described by the mail transfer server apparatus which transfers the electronic mail message, after the electronic mail message is transmitted from the transmission source. Thus, it is possible to determine whether the transmission source is fabricated at a certain level of accuracy, by checking the character string indicating the domain in the trace information described in the mail header with the character string indicating the domain in the transmission source electronic mail address, or by checking the character strings indicating the domain in the plurality of pieces of trace information subsequently described in the mail header. Thus, a person who receives the electronic mail message to which a determination result based on the trace information is added checks the determination result, to thereby determine whether there is a doubt of fabrication in the transmission source of the received electronic mail message.

### BRIEF DESCRIPTION OF DRAWINGS

FIG. 1 is a diagram illustrating an overall configuration of an electronic mail transfer system including a relay apparatus according to an embodiment of the invention.

FIG. 2 is a block diagram illustrating a configuration of a relay apparatus shown in FIG. 1.

FIG. 3 is a diagram illustrating an electronic mail transmission process which is an operation of an electronic mail transfer system shown in FIG. 1.

FIG. 4 is a diagram illustrating an example of an electronic mail message transmitted in step S160 which is the electronic mail transmission process in FIG. 3.

FIG. 5 is a diagram illustrating an example of an electronic mail message in which trace information in step S180 which is the electronic mail transmission process in FIG. 3 is described.

FIG. 6 is a diagram illustrating an example of an electronic mail message in which trace information in step S260 which is the electronic mail transmission process in FIG. 3 is described.

FIG. 7 is a diagram illustrating an electronic mail reception process which is an operation of an electronic mail transfer system shown in FIG. 1.

FIG. 8 is a diagram illustrating an operation according to another embodiment of the invention.

### DESCRIPTION OF EMBODIMENTS

Hereinafter, embodiments of the invention will be described with reference to the accompanying drawings.

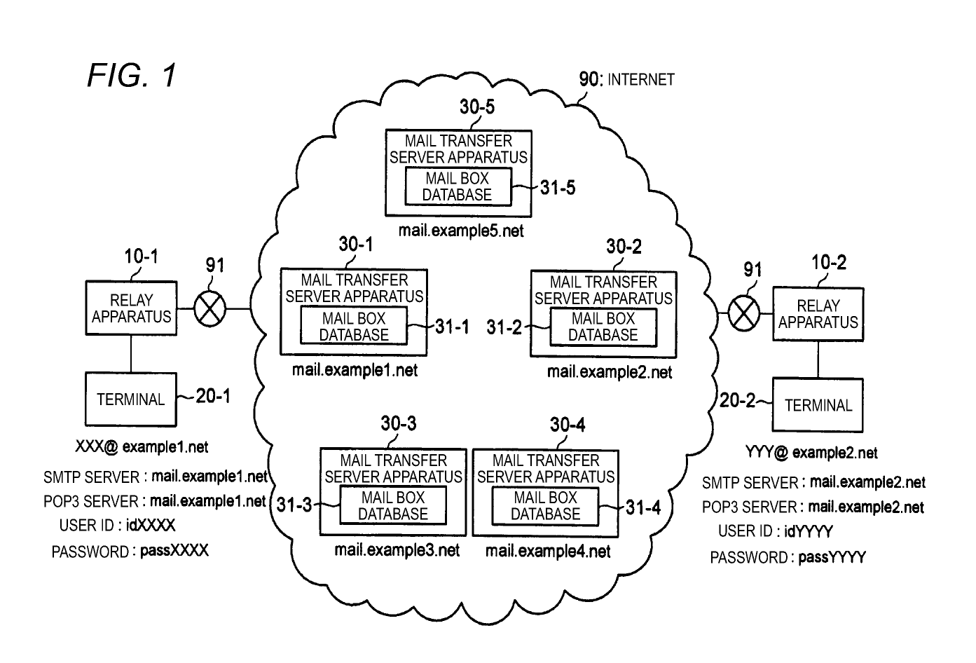

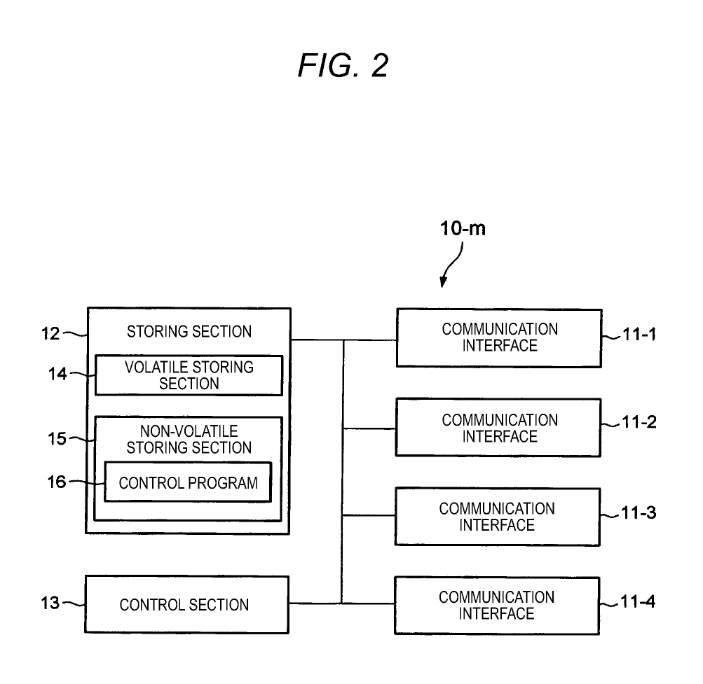

FIG. 1 is a diagram illustrating an overall configuration of an electronic mail transfer system including relay apparatuses 10-m (m=1, 2, . . . ) according to an embodiment of the present invention, and FIG. 2 is a block diagram illustrating a configuration of the relay apparatus 10-m (m=1, 2, . . . ).

In FIG. 2, the relay apparatus 10-m (m=1, 2, . . . ) includes communication interfaces 11-k (k is 1 to 4), a storing section 12 and a control section 13. The communication interfaces 11-k (k is 1 to 4) are NICs (Network Interface Card). At least one (for example, communication interface 11-1) of the communication interfaces 11-k of the relay apparatus 10-m (m=1, 2, . . . ) is connected to a line 91 which is linked with the Internet 90, and at least one remaining (for example, communication interface 11-2) is connected to terminals 20-i which form a LAN (Local Area Network) together with the relay apparatus 10-m. The communication interfaces 11-1 and 11-2 receive an Ethernet frame (registered trademark) (hereinafter, simply referred to as a “frame”) in which MAC addresses of the communication interfaces 11-1 and 11-2 are used as destination MAC addresses, and then deliver a data packet included in the frame to the control section 13.

The storing section 12 includes a volatile storing section 14 and a non-volatile storing section 15. The volatile storing section 14 is a RAM and supplies a work area to the control section 13. The non-volatile storing section 15 is a hard disk or a Flash ROM, for example. In the non-volatile storing section 15 is stored a control program 16. The control program 16 is a program which allows the control section 13 to execute a transfer process, an electronic mail storing process and a transmission source verification process.

In the transfer process, in a case where the destination IP addresses of the data packet delivered from the communication interfaces 11-1 or 11-2 belongs to the terminal 20-i under the relay apparatus 10-m, the frame including the data packet is transmitted from the communication interface 11-2, and in a case where the data packet does not belong to the terminal 20-i under the relay apparatus 10-m, that is, in a case where the transfer to the Internet 90 is required, the frame including the data packet is transmitted from the communication interface 11-1.

In the electronic mail storing process, in a case where the electronic mail message is included in a payload part of the data packet delivered from the communication interface 11-1, the electronic mail message is extracted from the data packet and then is stored in an area (referred to as a “verification request data storing area”) secured in the volatile storing section 14.

In the transmission source verification process, trace information indicating at least a part of a through point of the electronic mail message up to the corresponding relay apparatus 10-m from content described in a mail header mh of the electronic mail message stored in the verification request data storing area and an electronic mail address of a transmission source are obtained, and it is determined whether fabrication in the transmission source electronic mail address is present by checking the trace information and the transmission source electronic mail address. Then, the determination result is added to a mail body mb of the electronic mail message to assemble a data packet in which the electronic mail message is used as a payload part, and thus, a frame including the assembled data packet is transmitted from the communication interface 11-2.

Among the above-described three processes, the transfer process is a known process as a router, and the electronic mail storing process and the transmission source verification process are characteristic processes according to the present embodiment. The electronic mail storing process and the transmission source verification process will be described in detail later.

In FIG. 1, mail transfer server apparatuses 30-n (n=1, 2, . . . ) are server apparatuses which are installed with an SMTP and a POP3. The SMTP is a protocol associated with transmission of the electronic mail message by means of the terminals 20-i. The POP3 is a protocol associated with reception of the electronic mail message by means of the terminals 20-i.

The mail transfer server apparatus 30-n (n=1, 2, . . . ) has a unique host name. The host name is obtained by adding a character string (for example, “mail”) indicating a host which functions as the mail transfer server apparatus 30-n, before a character string indicating a domain to which the mail transfer server apparatus 30-n belongs. In an example of FIG. 1, a host name of a mail transfer server apparatus 30-1 is “mail.example1.net”, a host name of a mail transfer server apparatus 30-2 is “mail.example2.net”, a host name of a mail transfer server apparatus 30-3 is “mail.example3.net”, a host name of a mail transfer server apparatus 30-4 is “mail.example4.net”, and a host name of a mail transfer server apparatus 30-5 is “mail.example5.net”. The host names of the mail transfer server apparatuses 30-n (n=1, 2, . . . ) are stored in a DNS database of a DNS server apparatus (not shown) which belongs to the same domain, in accordance with respective IP addresses.

The terminals 20-i (i=1, 2, . . . ) are personal computers, for example, which are installed with a mailer program. The mailer program allows the terminals 20-i (i=1, 2, . . . ) to execute a process for generating, transmitting/receiving, and displaying an electronic mail message.

The electronic mail message which is generated and transmitted by the terminals 20-i (i=1, 2, . . . ) includes a mail body mb and a mail header mh. Further, a character string which forms a body text of the electronic mail message is described in the mail body mb. Further, header fields are described in the mail header mh. For example, the header fields include character strings as described below as field names, respectively.

a. Date

In the header field using this character string as its field name, creating date and time of the electronic mail message is described as a field value.

b. Subject

In the header field using this character string as its field name, a title of the electronic mail message is described as a field value.

c. To

In the header field using this character string as its field name, a destination electronic mail address is described as a field value.

d. From

In the header field using this character string as its field name, a transmission source electronic mail address is described as a field value.

The terminal 20-i (i=1, 2, . . . ) has a unique electronic mail address. In the example of FIG. 1, an electronic mail address of the terminal 20-1 is “XXX@example1.net”, and an electronic mail address of the terminals 20-2 is “YYY@example2.net”. Further, a host name of the mail transfer server apparatus 30-n (referred to as “SMTP server”) which requires connection establishment when each terminal 20-i transmits an electronic mail message, and a host name of the mail transfer server apparatus 30-n (referred to as “POP3 server”) which requires connection establishment when each terminal 20-i receives an electronic mail message are set in the terminal 20-i (i=1, 2, . . . ). In the example of FIG. 1, “mail.example1.net” which is the host name of the mail transfer server apparatus 30-1 is set as the host name of the SMTP server in the terminal 20-1, and “mail.example2.net” which is the host name of the mail transfer server apparatus 30-2 is set as the host name of the POP3 in the terminal 20-1, respectively. Further, a user ID and a password required when each terminal 20-i receives the electronic mail message from the POP3 server are set in the terminal 20-i (i=1, 2, . . . ). In the example of FIG. 1, in the terminal 20-1, a character string of “idXXXX” is set as a user ID, and a character string of “passXXXX” is set as a password. Further, in the terminal 20-2, a character string of “idYYYY” is set as a user ID, and a character string of “passYYYY” is set as a password.

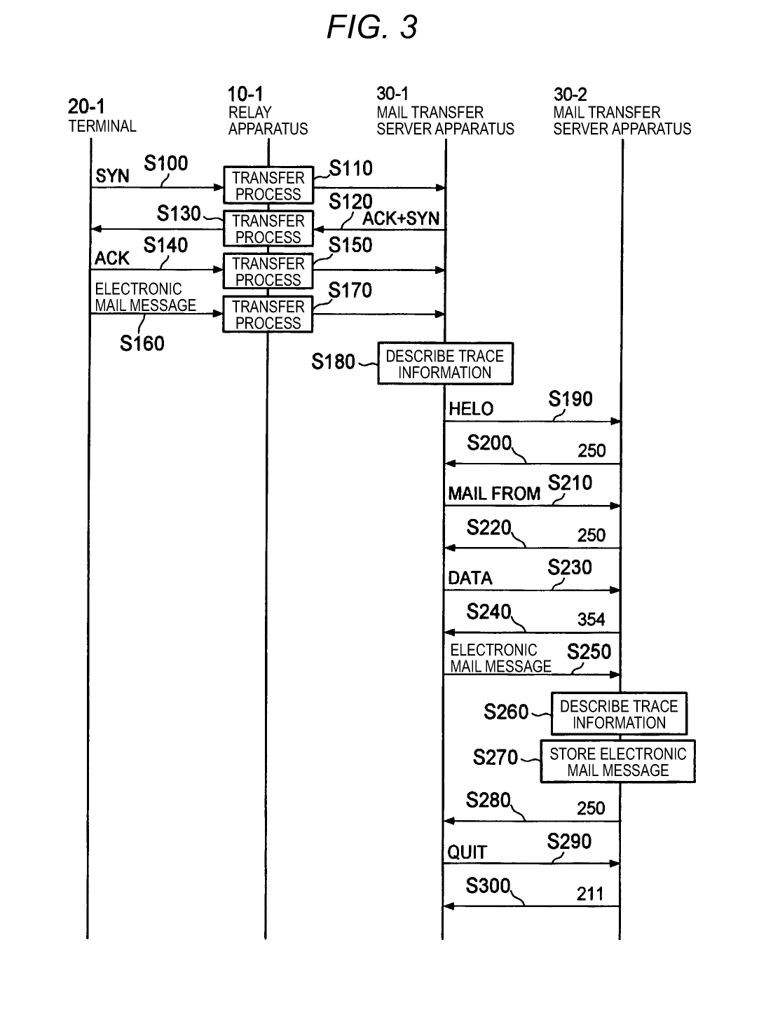

Next, an operation according to the present embodiment will be described. The operation in the present embodiment includes an electronic mail transmission process and an electronic mail reception process. FIG. 3 is a diagram illustrating an electronic mail transmission process in a case where the terminal 20-1 generates an electronic mail message in which an electronic mail address (YYY@example2.net) of the terminal 20-2 is used as a destination electronic mail address and transmits the electronic mail message. In FIG. 3, the processes performed by the terminal 20-1 and the mail transfer server apparatuses 30-1 and 30-2 are performed according to the SMTP.

In FIG. 3, the terminal 20-1 establishes connection with the mail transfer server apparatus 30-1 which is the STMP server of the terminal 20-1. Specifically, the terminal 20-1 transmits an inquiry including a character string of “mail.example1.net” which is the host name of the SMTP server of the terminal 20-1 to a DNS server apparatus (not shown) to thereby obtain an IP address of the mail transfer server apparatus 30-1, and then transmits a data packet of “SYN” in which the IP address is used as a destination IP address (S100). The data packet undergoes a transfer process through the relay apparatus 10-1 (S110), and then is transmitted to the mail transfer server apparatus 30-1. If the data packet of “SYN” is received, the mail transfer server apparatus 30-1 returns a data packet of “ACK+SYN” (S120). This data packet undergoes a transfer process through the relay apparatus 10-1 (S130), and then is delivered to the terminal 20-1. If the data packet of “ACK+SYN” is received, the terminal 20-1 returns a data packet of “ACK” (S140). The data packet undergoes a transfer process through the relay apparatus 10-1 (S150), and then is transmitted to the mail transfer server apparatus 30-1. Through the above-described processes, the connection between the terminal 20-1 and the mail transfer server apparatus 30-1 is established.

If the connection with the mail transfer server apparatus 30-1 is established, the terminal 20-1 transmits a data packet in which the electronic mail message is used as the payload part and the IP address of the mail transfer server apparatus 30-1 is used as the destination IP address (S160). The data packet undergoes a transfer process through the relay apparatus 10-1 (S170), and then is transmitted to the mail transfer server apparatus 30-1.

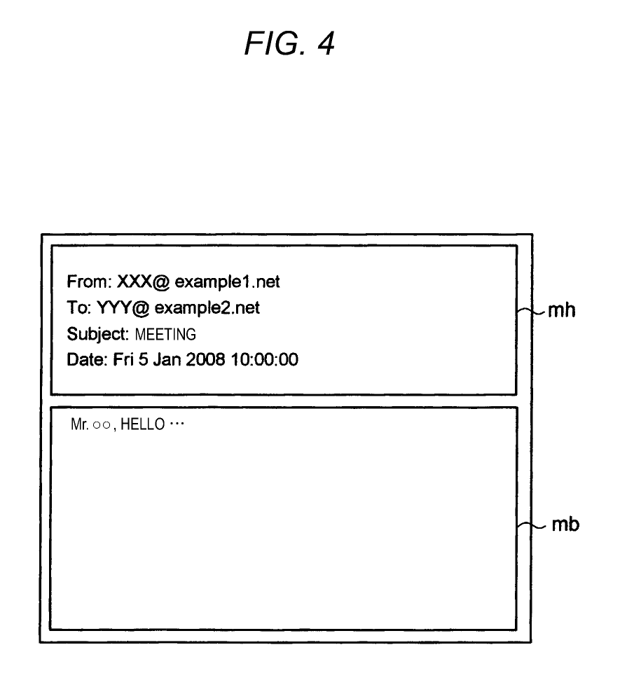

FIG. 4 is a diagram illustrating an example of the electronic mail message transmitted in step S160. As described above, the electronic mail message which is generated and transmitted by the terminal 20-i (i=1, 2, . . . ) has a mail body mb including a character string forming a mail body text, and a mail header including the respective header fields such as “Data”, “Subject”, “To” and “From”. Further, in the electronic mail message shown in FIG. 4, the character string of “XXX@example1.net” is described as a field value of the header field of “From”, and the character string of “YYY@example2.net” is described as a field value of the header field of “To”.

In FIG. 3, the mail transfer server apparatus 30-1 extracts an electronic mail message from the data packet received from the terminal 20-1, adds a new header field using “Received” as its field name to a mail header mh of the electronic mail message, and describes the trace information including the host name of the mail transfer server apparatus 30-1 as a field value in the header field of “Received” (S180).

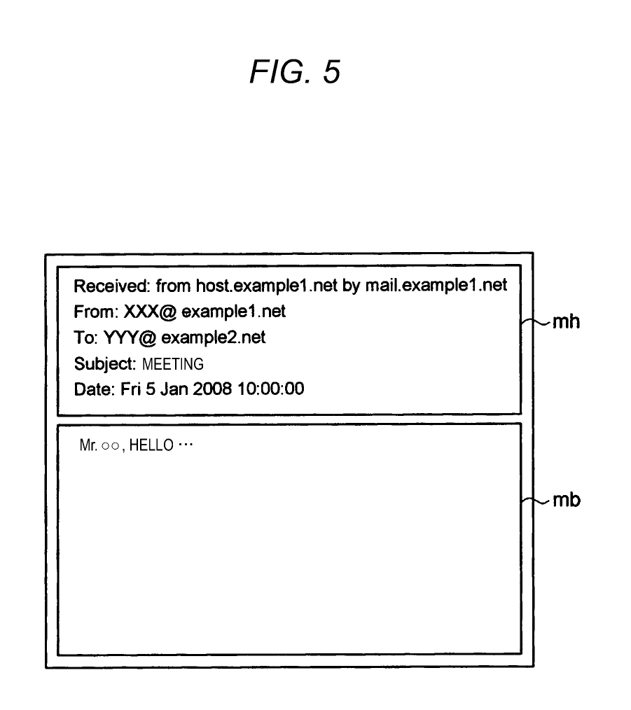

FIG. 5 is a diagram illustrating an example of the electronic mail message in which the trace information in step S180 is described. In the electronic mail message shown in FIG. 5 is described a header field of “Received” including trace information about a character string of “fromhost.example1.net by mail.example1.net”, in addition to the respective header fields of “Data”, “Subject”, “To” and “From”.

Next, the mail transfer server apparatus 30-1 extracts “example2.net” which is the character string corresponding to a domain name, from “YYY@example2.net” which is the field value of the header field of “To” of the electronic mail message, and transmits an inquiry including the character string to a DNS server apparatus (not shown), to thereby obtain an IP address of the mail transfer server apparatus 30-2. Further, the mail transfer server apparatus 30-1 transmits a data packet in which a character string of “HELO” is used as the payload part and an IP address of the mail transfer server apparatus 30-2 is used as the destination IP address, (S190). In the SMTP, the character string of “HELO” represents a command which requires a communication start.

If the data packet is received and the character string of “HELO” is obtained from the payload part, the mail transfer server apparatus 30-2 returns a data packet in which a character string of “250” is used as the payload part (S200). In the SMTP, the character string of “250” represents a response in a case where a command is normally received.

If the data packet is received and the character string of “250” is obtained from the payload part, the mail transfer server apparatus 30-1 returns a data packet in which a character string of “MAIL FROM: <XXX@example1.net>” is used as the payload part (S210). In the SMTP, the character string of “MAIL FROM” represents a command which requires reception of a subsequent character string as a transmission source electronic mail address.

If the data packet is received and the character string of “MAIL FROM: <XXX@example1.net>” is obtained from the payload part, the mail transfer server apparatus 30-2 returns a data packet in which a character string of “250” is used as the payload part (S220).

If the data packet is received and the character string of “250” is obtained from the payload part, the mail transfer server apparatus 30-1 returns a data packet in which a character string of “DATA” is used as the payload part (S230). In the SMTP, the character string of “DATA” represents a command which requires reception of the electronic mail message.

If the data packet is received and the command of “DATA” is obtained from the payload part, the mail transfer server apparatus 30-2 returns a data packet in which a character string of “354” is used as the payload part (S240). In the SMTP, the character string of “354” represents a response which requires delivery of the electronic mail message.

If the data packet is received and the character string of “354” is obtained from the payload part, the mail transfer server apparatus 30-1 returns a data packet in which the electronic mail message in which the trace information is described in step S180 is used as the payload part (S250).

If the data packet is received and the electronic mail message is obtained from the payload part, the mail transfer server apparatus 30-2 adds a new header field in which “Received” is used as its field name to the mail header mh of the electronic mail message, and describes the trace information including the host name of the mail transfer server apparatus 30-2 in the header field of the “Received” as the field value (S260).

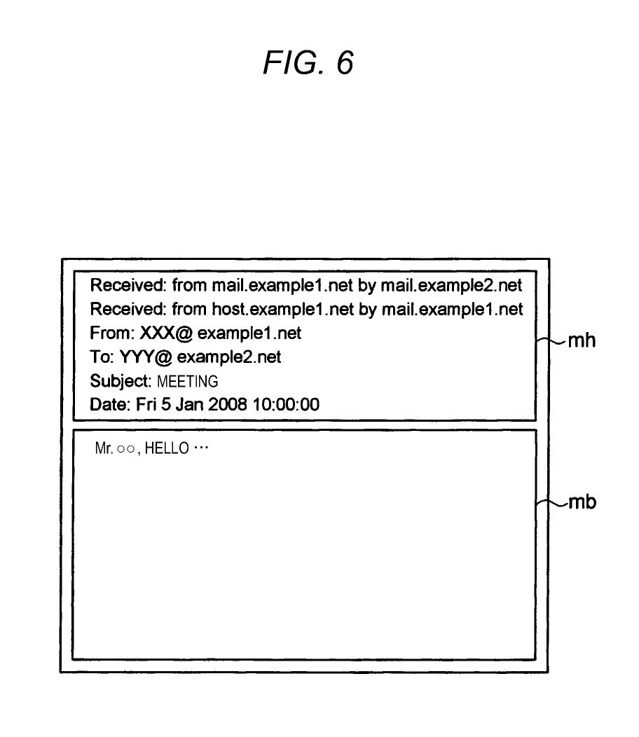

FIG. 6 is a diagram illustrating an example of the electronic mail message in which the trace information is described in step S260. In the electronic mail message shown in FIG. 6 is described a header field of “Received” including the trace information having a character string of “from mail.example1.net by mail.example2.net”, in addition to the respective header fields of “Date”, “Subject”, “To” and “From” and the header field of “Received” including the trace information having the character string of “fromhost.example1.net by mail.example1.net”.

After the electronic mail message in which the trace information is described in step S260 is stored in a mail box database 31-2 (S270), the mail transfer server apparatus 30-2 returns a data packet in which a character string of “250” is used as the payload part (S280).

If the data packet is received and the character string of “250” is obtained from the payload part, the mail transfer server apparatus 30-1 returns a data packet in which a character string of “QUIT” is used as the payload part (S290). In the SMTP, the character string of “QUIT” represents a command which requires termination of the process.

If the data packet is received and the character string of “QUIT” is obtained from the payload part, the mail transfer server apparatus 30-2 returns a data packet in which a character string of “221” is used as the payload part (S300). In the SMTP, the character string of “221” represents a response which notifies termination of the process. Through the return of the data packet in which the character string of “221” is used as the payload part, the electronic mail transmission process is terminated.

As described above, in the electronic mail transmission process, the mail transfer server apparatus 30-n (n=1, 2, . . . ) describes the header field of “Received” including the trace information which is the host name thereof, in the mail header mh of the electronic mail message passing through the mail transfer server apparatus 30-n.

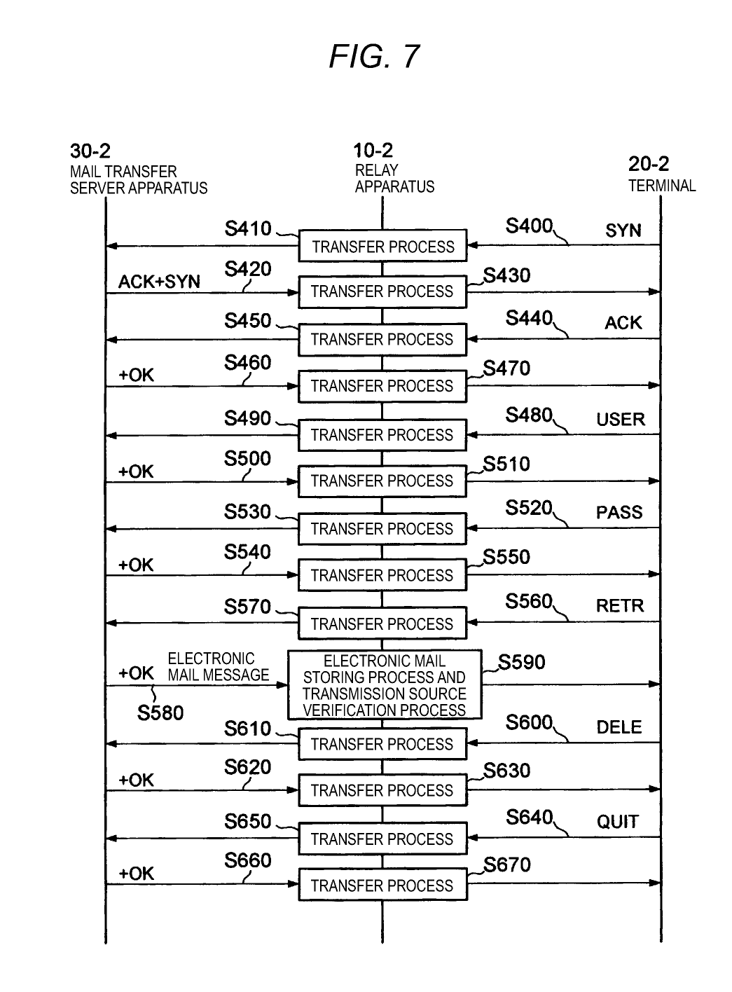

FIG. 7 is a diagram illustrating an electronic mail reception process in a case where the terminal 20-2 receives an electronic mail message in which an electronic mail address of the terminal 20-2 is used as a destination electronic mail address. In FIG. 7, the processes performed by the mail transfer server apparatus 30-2 and the terminal 20-2 are performed according to the POP3.

In FIG. 7, the terminal 20-2 establishes connection with the mail transfer server apparatus 30-2 which is the POP server of the terminal 20-2. The connection establishment is performed in the same order as in steps S100 to S150 in FIG. 3 (S400 to S450).

If the connection with the terminal 20-2 is established, the mail transfer server apparatus 30-2 transmits a data packet in which a character string of “+OK” is used as the payload part and the IP address of the terminal 20-2 is used as the destination IP address (S460). In the POP3, the character string of “+OK” represents a response in a case where the process is normally performed. The data packet undergoes a transfer process through the relay apparatus 10-2 (S470), and then is delivered to the terminal 20-2.

If the data packet is received and the character string of “+OK” is obtained from the payload part, the terminal 20-2 returns a data packet in which a character string of “USER idYYYY” is used as the payload part (S480). In the POP3, the character string of “USER” represents a command which requires reception of a subsequent character string as the user ID. The data packet undergoes the transfer process through the relay apparatus 10-2 (S490), and then is transmitted to the mail transfer server apparatus 30-2.

If the data packet is received and the character string of “USER idYYYY” is obtained from the payload part, the mail transfer server apparatus 30-2 performs ID authentication using “idYYYY” and then returns a data packet in which a character string of “+OK” is used as the payload part (S500). The data packet undergoes a transfer process through the relay apparatus 10-2 (S510), and then is delivered to the terminal 20-2.

If the data packet is received and the character string of “+OK” is obtained from the payload part, the terminal 20-2 returns a data packet in which a character string of “PASS passYYYY” is used as the payload part (S520). In the POP3, the character string of “PASS” represents a command which requires reception of a subsequent character string as a password. The data packet undergoes a transfer process through the relay apparatus 10-2 (S530), and then is transmitted to the mail transfer server apparatus 30-2.

If the data packet is received and the character string of “PASS passYYYY” is obtained from the payload part, the mail transfer server apparatus 30-2 performs password authentication using “passYYYY” and then returns a data packet in which a character string of “+OK” is used as the payload part (S540). The data packet undergoes a transfer process through the relay apparatus 10-2 (S550), and then is delivered to the terminal 20-2.

If the data packet is received and the character string of “+OK” is obtained from the payload part, the terminal 20-2 returns a data packet in which a character string of “RETR” is used as the payload part (S560). In the POP3, the character string of “RETR” represents a command which requires delivery of the electronic mail message. The data packet undergoes a transfer process through the relay apparatus 10-2 (S570), and then is transmitted to the mail transfer server apparatus 30-2.

If the data packet is received and the character string of “RETR” is obtained from the payload part, the mail transfer server apparatus 30-2 reads out an electronic mail message in which “YYY@example2.net” is used as the destination electronic mail address, among electronic mail messages stored in the mail box database 31-2, and returns a data packet in which a character string of “+OK” and the electronic mail message are used as the payload part (S580).

Here, in the payload part of the data packet transmitted from the mail transfer server apparatus 30-2 in step S580, an electronic mail message is included. Accordingly, if the data packet having the electronic mail message is delivered from the communication interface 11-1, the control section 13 of the relay apparatus 10-2 performs the electronic mail storing process and the transmission source verification process (S590). Specifically, the control section 13 of the relay apparatus 10-2 extracts the electronic mail message from the data packet, performs the electronic mail storing process which is a process of storing the electronic mail in the verification request data storing area of the volatile storing section 14, and then performs the transmission source verification process in the following order.

Firstly, the control section 13 searches the header field including the character string of “Received” and the header field including the character string of “From”, from the mail header mh of the electronic mail message in the verification request data storing area, respectively. Then, the control section 13 extracts the character string indicating the domain name of the server in which the header fields are described, from the trace information which is the field value of the header field including the character string of “Received”. For example, in a case where the trace information on one header field including the character string of “Received” is “from hots.example1.net by mail.example1.net” and trace information on another header field is “from mail.example1.net by mail.example2.net”, the character strings of “example1.net” and “example2.net” subsequent to “by mail.” are extracted, respectively. Further, the control section 13 extracts a character string indicating the domain name from the transmission source electronic mail address which is the field value of the header field including the character string of “From”. For example, in a case where the destination electronic mail address of the header field including the character string of “From” is “XXX©example1.net”, the character string of “example1.net” subsequent to “@” is extracted.

Further, the control section 13 checks the character string extracted from the trace information with the character string extracted from the transmission source electronic mail address. Then, if the character string extracted from at least one piece of the trace information and the character string extracted from the transmission source electronic mail address are the same, a determination result indicating that the transmission source electronic mail address is not fabricated (for example, a character string of content “the transmission source of this electronic mail is reliable”) is described in the mail body mb, and if not, a determination result indicating that the transmission source electronic mail address is fabricated (for example, a character string of content “the transmission source of this electronic mail message is fabricated”) is described in the mail body mb.

If the determination result is described in the mail body mb of the electronic mail message in the verification request data storing area, the control section 13 assembles a data packet in which the electronic mail message is used as the payload part and the IP address of the terminal 20-2 is used as the destination IP address, and transmits a frame including the data packet from the communication interface 11-2. The data packet is delivered to the terminal 20-2.

If the data packet is received and the electronic mail message is obtained from the payload part, the terminal 20-2 transmits a data packet in which a character string of “DELE” is used as the payload part and the IP address of the mail transfer server apparatus 30-2 is used as the destination IP address (S600). In the POP3, the character string of “DELE” represents a command which requires deletion of the electronic mail message from the mail box database 31-2. The data packet undergoes a transfer process through the relay apparatus 10-2 (S610), and then is transferred to the mail transfer server apparatus 30-2.

If the data packet is received and the character string of “DELE” is obtained from the payload part, the mail transfer server apparatus 30-2 deletes the same electronic mail message as the electronic mail message read out in step S580 from the mail box database 31-2, and then returns a data packet in which a character string of “+OK” is used as the payload part (S620). The data packet undergoes a transfer process through the relay apparatus 10-2 (S630), and then is delivered to the terminal 20-2.

If the data packet is received and the character string “+OK” is obtained from the payload part, the terminal 20-2 returns a data packet in which a character string of “QUIT” is used as the payload part (S640). In the POP3, the character string of “QUIT” represents a command which requires termination of the process. The data packet undergoes a transfer process through the relay apparatus 10-2 (S650), and then is delivered to the mail transfer server apparatus 30-2.

If the data packet is received and the character string of “QUIT” is obtained from the payload part, the mail transfer server apparatus 30-2 returns a data packet in which a character string of “+OK” is used as the payload part (S660). The data packet undergoes a transfer process through the relay apparatus 10-2 (S670), and then is delivered to the terminal 20-2. Through reception of the data packet in the terminal 20-2, the electronic mail reception process is terminated.

As described above, in the electronic mail reception process, in a case where an electronic mail message is included in the data packet transmitted to the terminal 20-i through the relay apparatus 10-m from the mail transfer server apparatus 30-n, the relay apparatus 10-m (m=1, 2, . . . ) stores the electronic mail message in the verification request storing area, describes the string character indicating the presence or absence of fabrication in the transmission source electronic mail message in the mail body mb, and then delivers it to the terminal 20-i. Then, in the terminal 20-i which receives the electronic mail message, the character string indicating the presence or absence of fabrication, which is described in the mail body mb of the electronic mail message, is displayed as a part of a body text of the mail. Thus, it is possible to allow any receiver who is not capable of checking the path or the like of the electronic mail message which is received by the receiver to easily determine whether the electronic mail message is a so-called junk mail.

Further, the relay apparatus 10-m (m=1, 2, . . . ) considers that the transmission source electronic mail address is not fabricated in a case where the transmission source electronic mail address of the header field of “From” in the mail header mh of the electronic mail message and the trace information of the header field of “Received” include the character string of the same domain name, and considers that the transmission source electronic mail address is fabricated in a case where they do not include the character string of the same domain name. According to such a process, it is possible to accurately distinguish between the electronic mail message in which the transmission source electronic mail address is fabricated and the electronic mail message in which the transmission source electronic mail address is not fabricated. The reason follows hereinafter.

Generally, an electronic mail address is allocated to a normal user from a trader (for example, Internet service provider) who occupies a certain domain. To a terminal 20-i (for example, terminal 20-1) of the user, the host name of the mail transfer server apparatus 30-1 which belongs to a domain of the trader which is an allocation source of the electronic mail address is set as a host name of the SMTP server. On the other hand, since a transmitter of junk mail transmits a massive amount of electronic mail messages in a short period of time, using a variety of electronic mail addresses which are fraudulently misappropriated from others as transmission source electronic mail addresses, the transmitter does not change settings of the SMTP server to a computer of the transmitter according to domain names of the transmission source electronic mail addresses whenever transmitting the electronic mail messages one by one. Thus, in a case where the electronic mail message in which the electronic mail address (XXX@example1.net) of the terminal 20-1 is used as the transmission source address is transmitted from the computer of such a transmitter, the electronic mail message firstly passes through the mail transfer server apparatus 30-n (n≠1) which is not the SMTP server of the terminal 20-1, and then is transferred. Accordingly, in a case where the transmission source electronic mail address of the header field of “From” in the mail header mh of the electronic mail message and the trace information of the header field of “Received” do not include the same domain name, it is possible to consider that the transmission source electronic mail address of the electronic mail message is fabricated.

Hereinbefore, the exemplary embodiment of the present invention has been described, but other embodiments may be realized in this invention, examples of which are as follows.

(1) In the above-described embodiment, the relay apparatus 10-m (m=1, 2, . . . ) describes the determination result that the transmission source of the electronic mail address is not fabricated, or the determination result that the transmission source of the electronic mail is fabricated, in the mail body mb of the electronic mail message. However, the verification result may be described in the mail header mh of the electronic mail message.

(2) The data transmission process and the data reception process in the above-described embodiment are an example of transmission and reception of the commands and the responses in the SMTP and the POP3, and transmission and reception of commands and responses other than the above-described commands and responses may be performed. For example, in the data reception process, before transmission and reception of the command of “RETR” and the response of “+OK”, transmission and reception of a command of “STAT” indicating state notification and a response of “+OK” may be performed, and before transmission and reception of the command of “RETR” and the response of “+OK”, transmission and reception of a command of “LIST” which requires for notification of the total number of the electronic mail messages delivered to the terminal 20-i or the byte number of each electronic mail message and a response of “+OK” may be performed. Moreover, the data reception process may be performed according to APOP (Authenticated Post Office Protocol) or IMAP (Internet Message Access Protocol).

(3) In the above-described embodiment, the number of the communication interfaces included in the relay apparatus 10-m (m=1, 2, . . . ) may be two or three, or may be five or more.

(4) In the electronic mail reception process according to the above-described embodiment, the control section 13 of the relay apparatus 10-m (m=1, 2, . . . ) extracts the character string indicating the domain name from trace information about an initially described header field among the plurality of header fields including the character string of “Received” which is described in the mail header of the electronic mail message, and checks the extracted character string with the character string of the domain name in the transmission source electronic mail address.

(5) The control program 16 in the above-described embodiment may be installed in the mail transfer server apparatus 30-n (n=1, 2, . . . ), and when the mail transfer server apparatus 30-n (n=1, 2, . . . ) receives an electronic mail message which requires storing in the mail box database 31-n (n=1, 2, . . . ) of the mail transfer server apparatus 30-n (n=1, 2, . . . ) from a different mail transfer server apparatus 30-n (n=1, 2, . . . ), both the electronic mail storing process and the transmission source verification process electronic mail storing process may be performed.

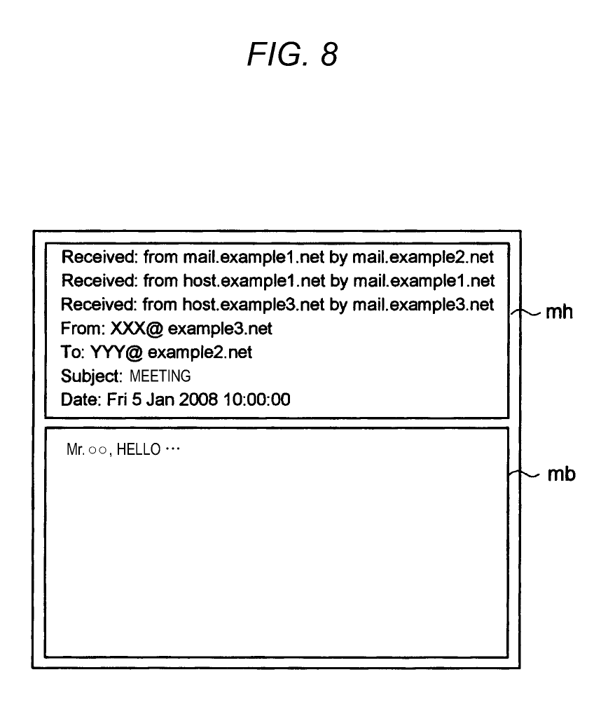

(6) According to the electronic mail reception process in the above-described embodiment, in a case where a transmitter of junk mail transmits an electronic mail message in which an electronic mail address misappropriated from others and false trace information are described, the control section 13 of the relay apparatus 10-m may not correctly determine the presence or absence of fabrication in the transmission source address of the electronic mail message. A specific example thereof will be described. In a case where the transmitter of junk mail transmits an electronic mail message in which an electronic mail address stolen from others (“XXX@example3.net”, for example) and false trace information (“from host.example3.net by mail.example3.net”) which pretends to correspond to a mail transfer server apparatus 30-n having the same domain name as the domain name included in the electronic mail address are described, from the computer of the transmitter, the electronic mail message undergoes description of the trace information through one or plural mail transfer server apparatuses 30-n on the transfer path, and then, is stored in the verification request data storing area of the relay apparatus 10-m as the electronic mail message of the description content shown in FIG. 8, for example.

Then, in a case where the electronic mail message which is described in the verification request data storing area becomes the description content shown in FIG. 8, since a character string subsequent to the oldest “by mail.” and a character string subsequent to “@” of the electronic mail address among three pieces of trace information described as the header field of “Received” in the mail header mh indicate the domain name of “example3.net”, the control section 13 mistakenly determines that the transmission source electronic mail address is not fabricated.

Thus, the control section 13 may perform a process of checking the character string subsequent to “by mail.” in the trace information about the header field including the character string of “Received” with the character string subsequent to “@” of the transmission source electronic mail address as a first check process, may perform a second check process which will be described later in addition to the first check process, and may determine the presence or absence of the fabrication in the transmission source electronic mail address on the basis of the process results of the two processes.

In the second check process, the control section 13 sets the oldest trace information and the second oldest trace information among the plurality of pieces of trace information described in the plurality of header fields including the character string of “Received” in the mail header mh as a reference target. Then, the control section 13 checks the character string (“example3.net” in the example of FIG. 8) subsequent to “by mail.” in the oldest trace information with the character string (“example1.net” in the example of FIG. 8) subsequent to “from host.” (or combination of “from” and a character string indicating a host name, such as “from mail”) in the second oldest trace information. Then, in a case where the character strings checked by the first check process are the same and the character strings checked by the second check process are the same, the control section 13 determines that the transmission source electronic mail address is not fabricated.

Further, the control section 13 may determine the presence or absence of fabrication in the transmission source electronic mail address on the basis of only the result of the second check process, without performing the first check process.

(7) The control program 16 in the above-described embodiment may be downloaded to a computer from a server apparatus on WWW (World Wide Web), and the computer may function as the relay apparatus. Further, such a program may be stored in the storing medium for distribution.

The specific embodiments according to the present invention have been described in detail, but it is obvious to those skilled in the art that a variety of modifications can be performed in a range without departing from the spirit of the invention.

The present application contains subject matter related to that disclosed in Japanese Priority Patent Application JP 2008-226518 filed in the Japan Patent Office on Sep. 3, 2008, the entire contents of which are hereby incorporated by reference.

1. A relay apparatus comprising:
a storage section configured to store an electronic mail message; and
a transmission source verification processing section that obtains trace information indicating at least a part of a through point of the electronic mail message up to the relay apparatus, from content described in a mail header of the electronic mail message stored in the storage section, determines the presence or absence of fabrication in a transmission source of the electronic mail message on the basis of the trace information, and adds a determination result about the presence or absence of the fabrication to a mail body or the mail header of the electronic mail message for transmission.

2. The relay apparatus according to claim 1, wherein the transmission source verification processing section determines the presence or absence of the fabrication by searching a header field including a character string of “Received” and a header field including a character string of “From” from the mail header, obtaining the trace information from content described in the header field including the character string of “Received”, obtaining an electronic mail address of the transmission source from content described in the header field including the character string of “From”, and checking the trace information with the electronic mail address of the transmission source.

3. The relay apparatus according to claim 2, wherein the transmission source verification processing section extracts, from the trace information, a character string indicating a domain to which a mail server being the through point of the electronic mail message belongs, extracts, from the electronic mail address of the transmission source, a character string indicating a domain to which the electronic mail address of the transmission source belongs, and checks the character string indicating the domain to which the mail server belongs and the character string indicating the domain to which the electronic mail address of the transmission source belongs.

4. The relay apparatus according to claim 1, wherein the transmission source verification processing section performs a first checking process of searching a header field including a character string of “Received” and a header field including a character string of “From” from the mail header and checking the trace information obtained from content described in the header field including the character string of “Received” with an electronic mail address of the transmission source obtained from content described in the header field including the character string of “From” and a second checking process of checking the plurality of pieces of trace information obtained from the content described in the plurality of header fields including the character string of “Received” to each other, and determines the presence or absence of the fabrication on the basis of results of the first checking process and the second checking process.

5. A relay method comprising:
storing an electronic mail message in a storage section;
obtaining trace information indicating at least a part of a through point of the electronic mail message up to a relay apparatus, from content described in a mail header of the electronic mail message stored in the storage section;
determining the presence or absence of fabrication in a transmission source of the electronic mail message on the basis of the trace information; and
adding a determination result about the presence or absence of the fabrication to a mail body or the mail header of the electronic mail message for transmission.

6. A computer-readable recording medium recording a program for causing a computer to execute the process comprising:
storing an electronic mail message in a storage section;
obtaining trace information indicating at least a part of a through point of the electronic mail message up to a relay apparatus, from content described in a mail header of the electronic mail message stored in the storage section;
determining the presence or absence of fabrication in a transmission source of the electronic mail message on the basis of the trace information; and
adding a determination result about the presence or absence of the fabrication to a mail body or the mail header of the electronic mail message for transmission.
